(19) United States
(12) Patent Application Publication
(10) Pub. No.: US 2002/0188497 A1
(43) Pub. Date: Dec. 12, 2002

(54) System and method for customer knowledge respository

(76) Inventor: Francis Anthony Cerwin, Carol Stream, IL (US)

Correspondence Address: Thomas J. Scott, Jr., Esq., Hunton & Williams, Suite 1200, 1900 K Street, N.W., Washington, DC, 20006, US

(21) Appl. No.: 09/878,393

(22) Filed: Jun. 12, 2001

(51) Int. Cl. G06F 17/60

(52) U.S. Cl. 705/10

(57) ABSTRACT

A system and method providing an integrated, comprehensive, centralized repository of customer relationships, channel access, customer analysis, and customer servicing information for retrieval and update when servicing customers or otherwise requested. The present invention provides an integrated front-end and seamless access to customer information for providing integration of production and service delivery processes to enhance an entity's knowledge of customers (and/or potential customers) and the customer's specific needs. The present invention further provides a method and system for identifying customers and interacting with the customers at an individual or grouped level. A customer knowledge repository may be used for managing relationship management assignments, determining customers within households (or other defined grouping), and distributing information to sales force, call center representatives, and automated self-service delivery channels thereby promoting consistent treatment of individual customers with a comprehensive understanding of the customer relationship within an enterprise.

### FIELD OF THE INVENTION

The invention relates to the field of customer relationship management services, and in particular, to providing an integrated, comprehensive solution that provides a centralized repository and standardized interface to customer information linkages, relationships, channel access, trusted third parties, servicing, and other information for retrieval and update at the point of contact.

### BACKGROUND OF THE INVENTION

In the financial services industry, a customer focused business model is required to compete in today's markets. Emphasis has shifted from a pure product sales approach to determining and satisfying what a customer wants and needs. Companies in other industries are realizing that they must also have a complete, integrated view of the customer to maintain a successful and long-standing customer relationship.

Traditionally, employees and systems do not have access to an integrated view of a complete perspective of information about a customer. Organizations are typically comprised of several units with Customer Information Files (CIFs) across systems, lines of business and business units. Disparate information sources create an environment that renders real-time access to a holistic view of the customer improbable and inefficient. This situation is compounded due to the shear size, geographic separation, and the number of mergers and acquisitions that characterize corporations today. In addition, marketing and sales departments must deal with an increasing number and varying types of delivery channels to support customers. All of these factors result in customer views that are channel specific and incomplete. Thus, individual customers are difficult to identify. As a result, customers are not served in a comprehensive and consistent manner.

### SUMMARY OF THE INVENTION

The invention overcoming these and other problems in the art relates to a system and methods for creating a comprehensive and integrated solution providing a centralized repository of knowledge of customer relationships, access controls, and servicing with a mechanism for retrieval and update at the point of contact with the customer. The present invention provides a cost-efficient method and system for identifying individual customers, storing customer and other associated information, tracking contacts with the customer and exchanging information seamlessly with the various systems and channels that may be used to interact with the customer.

The present invention provides an automated process for gathering and integrating customer profiles in a database, processing update and query requests on the customer profiles, and distributing profile information. Profile information may include transaction history, profitability analysis, customer contact, preferences, demographic data, psychographic profile, relationships to other customers or organizations, channel usage, and methods of identification and authentication used to recognize the customer at any point of contact.

According to an embodiment of the present invention, a customer knowledge repository may be used by several channels and systems processes, which include, but are not restricted to, An Automated Teller Machine (ATM) System, Interactive Voice Response (IVR) Bank-By-Phone System, Internet Banking System, Personal Financial Management desktop software (e.g., Quicken™, Quickbooks™, Microsoft Money™), Branch Bank Teller System, Call Center System, and Premier Client Management System for managing banking center and relationship manager assignments, and households or other defined grouping of customers.

### BRIEF DESCRIPTION OF THE DRAWINGS

FIG. 1 is an example of a diagram of a comprehensive customer-centric perspective of a customer, according to an embodiment of the present invention.

FIG. 2 is a diagram of a framework of system processes, according to an embodiment of the present invention.

FIG. 3 is a diagram of the logical data model of the Customer Knowledge Repository, according to an embodiment of the present invention.

FIG. 4 illustrates a logic flow for invoking the services of the present invention, according to an embodiment of the present invention.

FIG. 5 is a logic flow used to import customer information and relationships from application systems into a Customer Knowledge Repository, according to an embodiment of the present invention.

FIG. 6 is a logic flow used to import customer information and relationships from analytical systems to and from a Customer Knowledge Repository, according to an embodiment of the present invention.

FIG. 7 is a diagram of the conceptual data model of the Customer Knowledge Repository, according to an embodiment of the present invention.

FIG. 8 is an illustration of a set of functions that interact on a Customer Knowledge Repository to provide an interfacing system, according to an embodiment of the present invention.

### DETAILED DESCRIPTION OF THE PREFERRED EMBODIMENTS

A customer's relationship and interaction with an entity (e.g., a bank, service or product provider, etc.) may be multi-faceted. For example, a customer may use one or more of the available delivery channels (e.g., call center, Internet access, branch office, interactive voice response), to access multiple products (e.g., checking, loans, savings, investments), make multiple contacts (e.g., transactions, information requests, complaints), participate in one or more group memberships (e.g., household, business), hold external financial relationships (e.g., insurance, accounts at other financial institutions), and have life events and plans (e.g., children, college education, house addition, vacation, retirement). Further, customers (predominately businesses) may grant trusted third parties access to customer information, which may be common with accountant and financial planning advisor relationships, for example. Capturing, analyzing, distributing, and leveraging information regarding a customer's total perspective provides a business (or other entity) the ability to provide individualized and personalized service. This further enables an entity (e.g., a bank, product provider, service provider, etc.) the ability to customize and personalize information based on the knowledge of comprehensive customer relationships, current services, previous transactions, wants, and needs of the customer.

Individual customer profiles that may be contained within multiple disparate customer information systems (CIS) and other sources may be integrated into a single profile view using processes and database capabilities of the present invention. In addition, the present invention provides a comprehensive portfolio of accounts, services, and other information which may be accessible as a consolidated portfolio view by/for the customer or other authorized entity.

The present invention presents several advantages, which may include: (1) creating a common application infrastructure (i.e., architecture) to encourage a consistent approach to locating and servicing bank (or other) customers; (2) providing a universal customer portfolio perspective across the multiple core customer information and servicing systems of a bank's application portfolio; (3) enabling a common application interface for some or all systems to access and maintain customer information; (4) facilitating a high level of access security to customer information; and (5) satisfying a customers' desire for personalized interactions with full knowledge of some or all of previous interactions and personal requests.

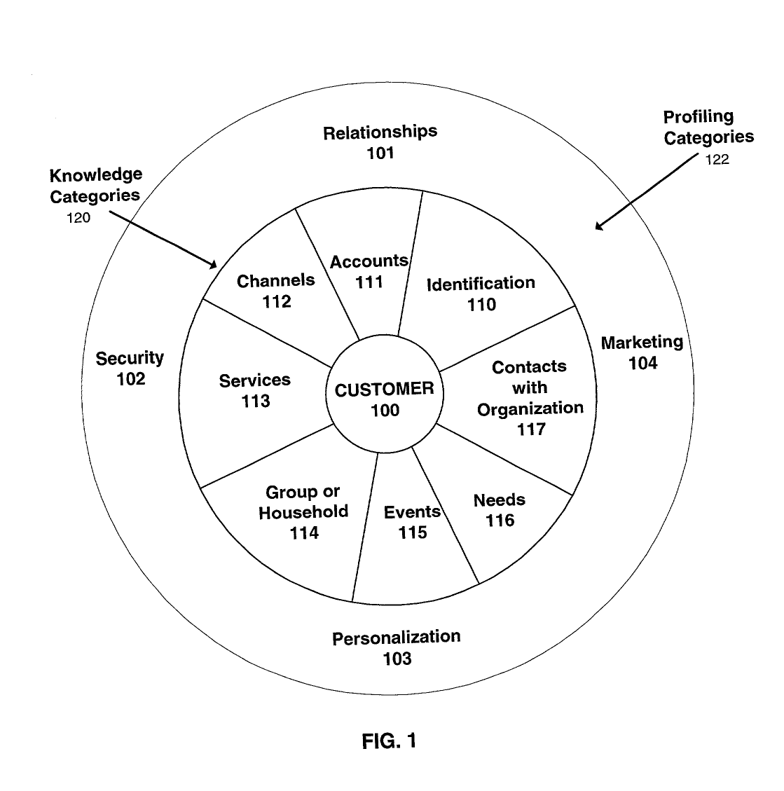

FIG. 1 is an example of a diagram of a comprehensive customer-centric perspective of a customer, according to an embodiment of the present invention. At the core of the view is Customer 100. The definition of a customer may vary across business units and systems. Customer 100 in the consumer environment may include a 1-to-1 correlation with an individual. However, a “Business Customer” presents a unique situation for customer identification and management. The “Business” as a legal entity does not actually interact with an organization. Rather, an authorized individual (such as an Authorized Agent) may transact and communicate on behalf of a business. A Customer Knowledge Repository of the present invention may be capable of maintaining the legal entity and Authorized Agent views of a business customer.

The customer may be identified within the invention by a unique ID assigned when a customer definition is imported into a Customer Knowledge Repository of the present invention. This unique ID may be a global, internal identifier that makes the customer definition unique across the entire enterprise. For example, some banking systems (e.g., legacy banking systems) typically maintain customer uniqueness only within a specific bank charter. Generally, an organization includes one or more Customer Information Systems (CIS) in place yet requires (or desires) an integration solution.

FIG. 1 illustrates Knowledge Categories 120 supported by an embodiment of the present invention surrounding customer 100. Knowledge categories may include identification 110, accounts 111, channels 112, services 113, group or household 114, events 115, needs 116, contact with organization 117 and other categories. For example, Knowledge Categories 120 may include identification methods 110 that a customer may use to identify one self to an organization. Identification methods 110 may include factors presented at the point of contact. For example, factors may include possessing a credit card or ATM card and knowing a user id, Social Security Number, PIN, password and/or other identifier. The present invention's design may support any and all factors of identification and authentication with differing factors at each customer channel. Due to the sensitive nature of this information, the invention may use a high level of encryption available to secure authentication information in transit to and from the present invention as well as when stored within a Customer Knowledge Repository. For example, the invention, through use of Public Key Infrastructure (PKI) encryption techniques and Host Security Modules (HSM) hardware may protect the customer's authentication information.

Products owned/held by the customer may be represented as Accounts 111. Types of Accounts may include, but are not restricted to, checking, savings, certificates of deposit (CD), installment loans, mortgage loan, and credit cards. For example, an account may possess a financial balance as an attribute. According to an embodiment of the present invention, an ATM/Debit Card may not be considered an Account as in many banking systems. The account(s) that a card may be associated with may maintain the financial balance and other data rather than the card itself. Therefore, an ATM/Debit card may be considered to be a form of access id at a channel (e.g., ATM, Point Of Sale, etc.). According to another example, a credit card may considered an account, as the credit card may be considered to be equivalent to a loan and has an associated financial balance. The present invention may receive account numbers and associated relationships to a customer from the CIS. Customers (including businesses) may have a variety of relationships to one or more accounts. As the account relationships are received, the present invention may create relationship links and access permissions (based on the type of account, age of the account, available service delivery channels, relationship of the customer to the account, etc.) within a Customer Knowledge Repository.

Another Knowledge Category comprising the customer experience with the organization may pertain to channels 112 that may enable a customer to interact with an organization (or other entity). Channels may be self or full service and provide transactional and service functionality to the customer. By their very nature, a channel's capabilities to deliver information and functions may vary by the channel's physical characteristics. Therefore, the present invention may maintain a separate profile for each channel in use by the customer. For example, the invention may support Internet, Interactive Voice Response (IVR), fax, PC-based software (e.g., Quicken™, Quickbooks™, Microsoft Money™), ATM, call center, and banking centers as supported channels. Other channels may also be supported. Per the customer's preference, access identification and password/PIN may be synchronized across channels or maintained uniquely by channel. The invention may maintain some or all of the attributes to identify, authenticate, track, and personalize at a channel level.

Another Knowledge Category of the customer-organization relationship may include Services 113 available to and/or requested by a customer 100. Services 113 that may be supported by the present invention may include remote banking, bill pay, and premier support. Services may be activated for a customer via various methods, including auto-enrollment, self-enrollment, or assisted enrollment. Based on a customer's privacy preferences, a service may be restricted from access at a specific channel(s) or may be available across some or all channels.

Group Membership 114 may allow multiple customer entities to be related together or grouped as a single entity. The group may represent a customer's consumer household (family), community (interest group), or business organization unit (district, region, holding company, etc.). A customer may be defined within one or multiple Group Membership Profiles. This grouping may be referred to as a “household”.

An organization's collective experience in financial matters may provide valuable resources to a customer. As such, customers may provide information about events that may be occurring within the customer's lifetime to a trusted banking advisor. Events 115 that may include the expected birth of a child, desire to start one's own business, an expected inheritance and other life events. Retained knowledge of these events provides analysis capabilities for appropriate financial strategy option recommendations to the customer.

Through the course of a customer's lifetime, financial goals and needs may vary. Financial and other needs 116 may be the result of long or short term plans or required on an immediate emergency basis. The present invention may retain customer needs that are gathered via surveys, face-to-face interaction, phone conversations, etc. The present invention's Customer Knowledge Repository recognizes needs 116 as a unique entity rather than captured in a generalized contact history in free-form text. A standard list of common needs may be defined, at 116, to simplify and codify entry and automated processes. In addition, other types of needs may be captured in the repository of the present invention.

Another Knowledge Category of the present invention may include Contacts with the Organization 117. A customer contact may include any call, visit, mailing, email, self-service channel session, dialogue, or correspondence between an organizational entity and a customer. The invention may retain every type of contact that may be possible with the customer in a centralized and standardized Customer Knowledge Repository. The contact nature may be a transaction, service request, complaint, comment, survey response, request for information, promotion or solicitation, and application for a product or service. As described below, a contact may have several attributes supported by the present invention.

The present invention provides customer Profiling Categories 122, which may include functions that provide query and update capabilities in the category of Relationships 101, Security 102, Personalization 103, and Marketing 104. Relationship functions 101 may enable the profiling of a customer, account relationships, household, contact events and/or other events.

Relationship functions 101 may provide various profiles of the customer including their demographics, relationships to the organization, relationships to other customers, and contacts with the organization.

Security and privacy functions 102 may provide a common interface and data storage for channel access, customer authentication, PIN/password verification, update, communication preferences, marketing program, channel opt out, and other operations. For example, an authentication function of the present invention may validate customer entered Access ID, PIN/password or other customer input for entry into a self-service channel. The present invention may retain information about when and how the password was chosen, the password expiration cycle, as well as other characteristics. PINs and passwords may be stored within a customer knowledge repository of the present invention using an encryption algorithm. Other supported PIN/password management functions may include out-of-band PIN mailer generation and excessive invalid PIN/password entry attempt lock-out.

Personalization functions 103 may maintain preferences pertaining to accounts, channels, privacy and other areas. Account personalization may include support of nicknames, auto-play (e.g., automatically perform balance inquiry on customer pre-specified accounts upon successful logon), short numeric reference codes to short-cut and sequence Interactive Voice Response (IVR) entry, and enablement/disablement of account access from a specified channel. Customer level personalization may include the ability to retain and maintain fax number, e-mail address and other contact information.

Marketing functions 104 may support product purchase propensity information and counters to play/display marketing messages at various channels. In another example, a customer may opt out of marketing material by channel where a customer may receive marketing material via mail, but not by telephone.

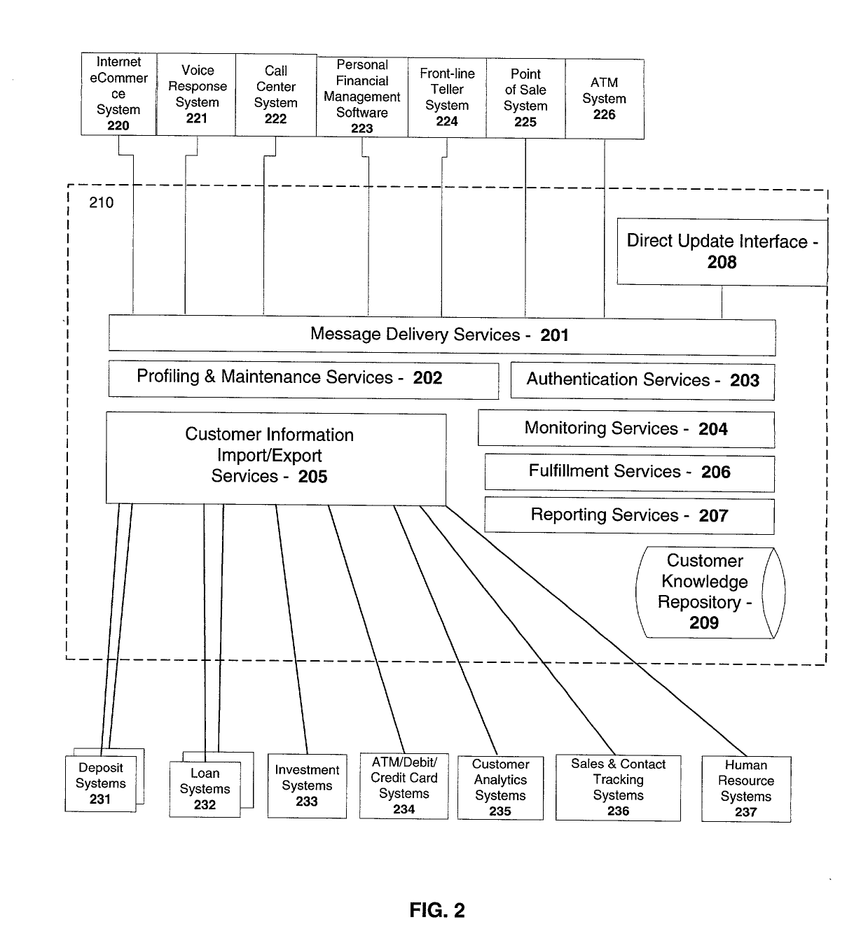

FIG. 2 is an example of a diagram of a framework of system processes for implementing a customer knowledge repository, according to an embodiment of the present invention. Reference numbers 201-209 illustrate a system for implementing a customer knowledge repository of the present invention. Delivery channel systems may include Internet eCommerce system 220, Voice Response System 221, Call Center System 222, Personal Financial Management Software 223, Front-line Teller System 224, Point of Sale System 225, ATM system 226 and other delivery channel systems. Business application systems may include Deposit Systems 231, Loan Systems 232, Investment Systems 233, ATM/Debit/Credit Card Systems 234, Customer Analytics Systems 235, Sales & Contract Tracking Systems 236, Human Resource Systems 237 and other application systems. Other external interfaces may interact with system 210 of the present invention. As specified, the invention encompasses distinct groupings of functionality.

Message Delivery Interface 201 may be used to route and deliver standardized and other messages between requesting external delivery channel interfaces and system 210. Delivery Channel Systems 220-226, regardless of type, may interact with system 210 in a common and standard fashion, thereby reducing overall programming effort and system maintenance expense across an organization's system application. Message Delivery Services 201 may perform load balancing of request message volume across multiple instances of Profiling & Maintenance Services 202. These services may encompass components of the system which may be invoked by various Delivery Channel Systems 220-226 via Message delivery services 201.

Profiling & Maintenance Services 202 may include various unique transactions to provide customer knowledge to calling external channel application interfaces and provide a means for updating customer knowledge in real-time when changes occur to the corresponding information. Every transaction performed within the knowledge repository may be recorded to an audit log and, in addition, may be retained within a contact history maintained by the present invention. For example, contacts may be captured from call center systems, self-service systems (e.g., Internet, ATM, Bank-by-Phone), and back-office systems (e.g., direct mail, sales tracking, account adjustment, and teller systems). In addition, contact history may be queried and delivered online and in real-time by external interface systems. Thus, the present invention provides a system that enables any and all contact with a customer to be recorded, regardless of type or purpose.

Reporting services 207 may provide an audit trail of activity performed within the system of the present invention. Monitoring Services 204 may provide a tool that delivers an online real-time view of transaction flow volume and system performance within the system. The present invention may track requests, processing response time, and resources used to execute functions to provide comprehensive snapshot views of performance and request message completions and failures. Viewing criteria can be specified at global and granular levels to provide a comprehensive snapshot of current and prior processing occurring within the system at any point in time.

Authentication Services 203 may be responsible for verifying the identity and authenticity of a customer at a point of contact. Customer identification and authentication may be implemented via one or more of User ID, ATM/Credit card number, biometrics, Social Security Number, digital certificate and password. The system of the present invention provides flexibility and the ability to adapt to multiple methods of identification and authentication. In addition, the invention utilizes strong encryption techniques to ensure the privacy of sensitive information as information is exchanged and stored. According to an embodiment of the present invention, the customer's password or PIN may not be exposed in clear text form within the system.

Customer Information Import/Export Services 205 provides a standardized method to exchange information from and to multiple Customer Information Systems (CIS) that may exist within organization(s). The services may be CIS system agnostic (independent of whether CIS is a vendor package or an in-house creation). CISs within an organization may be integrated within other core purchased and built application systems. External CISs may feed customer information to the system of the present invention in a standardized formatted message. The system may be implemented to replicate identification and authentication information in its repository and create linkages to associated CISs. The services may further include the ability to feed information from the system to the CIS when customer information held and maintained within the system is of interest to the CIS. Each disparate customer information system (CIS) may source the system of present invention with customers, accounts, customer-to-account relationships and other information. The present invention may maintain links back to each of these source systems. According to an embodiment of the present invention, information within a customer knowledge repository is kept synchronized with its CIS system of record source for data quality. Synchronization may be performed via batch and real-time methods.

Fulfillment Services 206 of the system may generate in-band and out-of-band fulfillment that may include customer letters, password mailers, etc. that may be used to fully service a customers needs. Just as all other contact is recorded by the system, each instance of fulfillment may also be recorded as a contact with the customer. Direct User Interface 208 provides an interface within the system (in addition to the external Delivery Channel Systems) to query and update information maintained within the customer knowledge repository. In addition, a set of screens and transactions may be available to authorized users. This interface may use the same message delivery services 201 as any other channel 220 through 226.

Customer Knowledge Repository 209 created and maintained by the system's processes provides separation of data and function processes. This approach allows for easy additions of functions without changes to the data structure and visa versa.

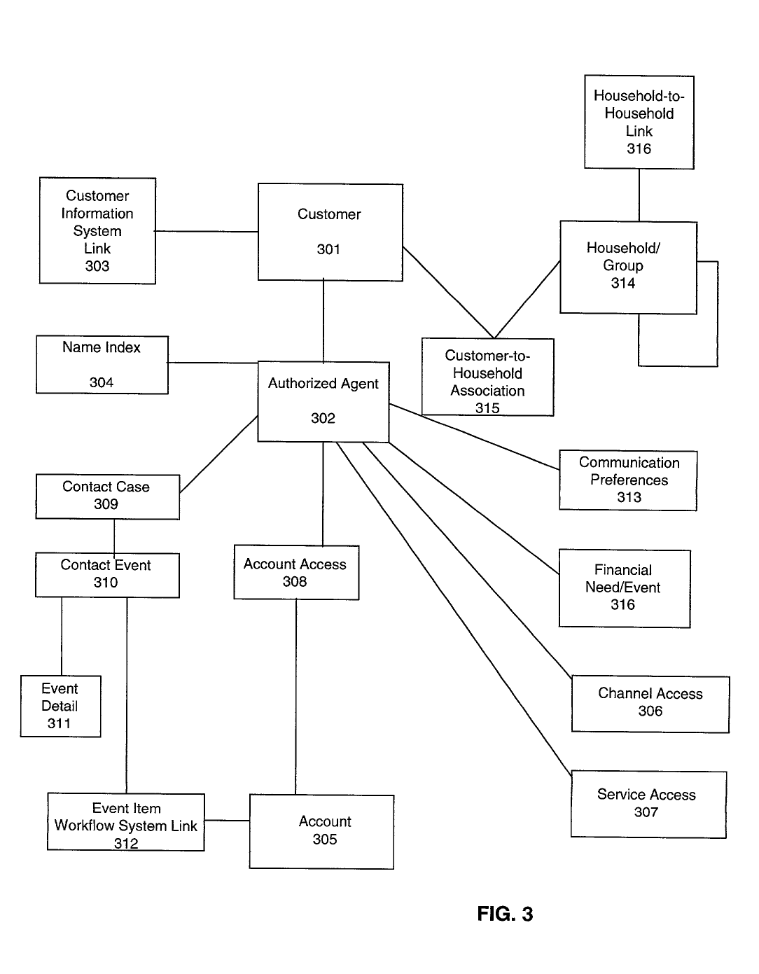

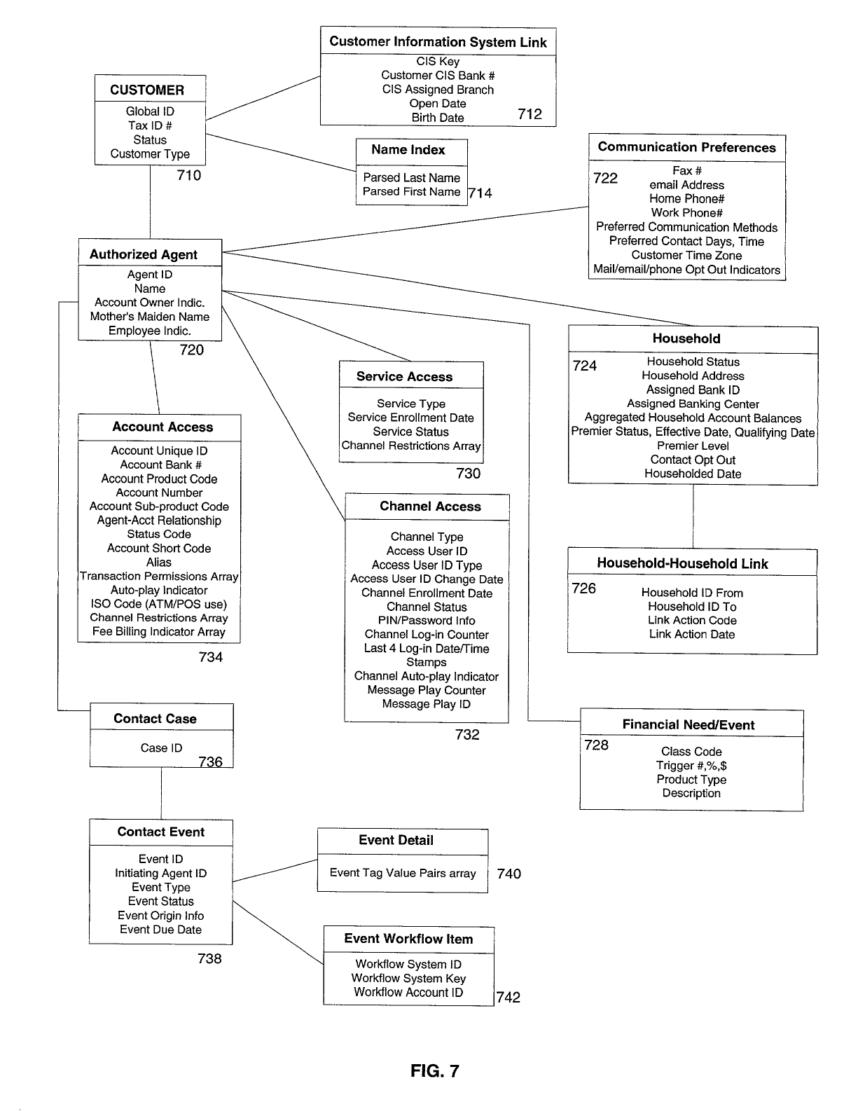

FIG. 3 depicts an example of a data model for a Customer Knowledge Repository, according to an embodiment of the present invention. Each depicted entity represents a grouping of related elements that define some attribute(s) pertaining to the definition of the entity. FIG. 7 further defines the elements within each entity.

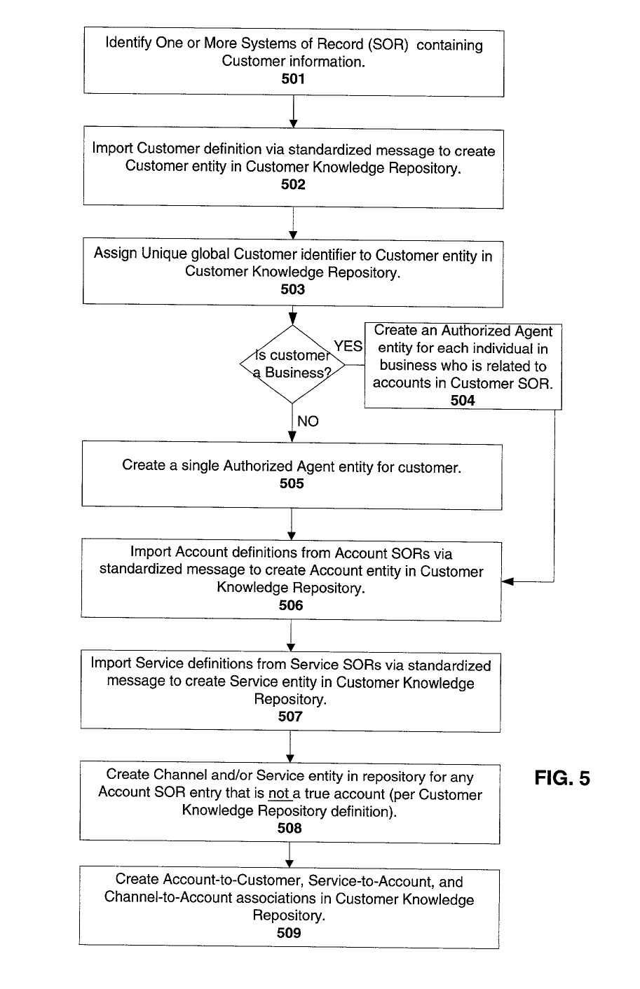

Customer 301 may be uniquely identified within a Customer Knowledge Repository independent of multiple customer information systems and potential customer key replications. An identifier (e.g., number) may be used for internal purposes to maintain a separate profile structure and may remain static throughout the duration of a customer's lifetime on the repository or as otherwise indicated. The identifier may be separate and distinct from the keys associated with the customer information systems (CIS) that may be used to populate the Customer Knowledge Repository. However, the CIS record keys and other identifying information about the customer may be retained within a Customer Information System Link 303 to provide direct links back to a system of record. When multiple definitions of the same customer exist in the CIS databases, the invention may provide a mechanism to associate any and all of these definitions with a single customer. Multiple CIS links may be related to a single Customer entity thereby providing a means to aggregate a customer's relationship that may spread across several back-end systems. The present invention provides a “super index” to relate a single customer to many customer system definitions of that customer quickly and with minimal impact on the system. Customer 301 and Customer Information System Link(s) 303 may be created during a Customer Information Import process, as illustrated in FIG. 5.

Related to Customer 301 may be one or more Authorized Agent 302. An Authorized Agent may be defined for each individual who has ownership and/or access rights to an account information of the customer. In an example of a consumer, there is usually one Authorized Agent defined for each single Customer. In the example of a business customer, it may be likely that several individuals (possibly numbering in the hundreds for large corporations) are granted access in some degree to the accounts of the business. Businesses may present a unique situation for customer identification. To an organization (e.g., a bank) and to each of the customer information systems, the customer may be considered to be the business. In this example, an authorized individual of the business may transact on behalf of the business entity. An Authorized Agent may be an individual who has access rights to one or more of the accounts of the business. For example, Authorized Agents may be identified by a combination of a selected Access ID of the business and assigned Authorized Agent ID. Additional Agents may be added as at any time requested by the business owner(s).

An Authorized Agent may also be added directly to a Customer Knowledge Repository to define an individual who is granted access privileges by the customer (e.g., trusted third party) but has not or can not be defined to a legacy CIS. An example is a small business who has contracted a part-time accountant to balance the books and is granted access by the business owners to account history and balances only. The present invention provides the ability to maintain and define these trusted third party relationships to the assets of a customer. For each Authorized Agent 302, a Name Index 304 may be created within a Customer Knowledge Repository to facilitate a search using a name by parsing a single name field from the CISs into the first and last name of the customer, for example.

A customer who performs banking functions through a self-service delivery channel may be assigned an Access ID that may be specific to the channel. Account Access 308 may involve various functional entitlements specific to account attributes, Authorized Agent relationship, and company policy.

Channel Access 306 may involve various methods of establishing access via a specific channel by an Authorized Agent. A facet of the customer experience may include using one or more self-service or full-service channels to access one or more financial accounts in a portfolio. Channels may vary in characteristics and capabilities. According to an embodiment of the present invention, a customer knowledge repository may maintain a separate profile for each channel in use by the customer. Full-service channels may include call centers and banking centers. Self-service channels may include one or more of Internet banking, bank by phone, fax, ATM, Point of Sale (POS), Quicken™, Microsoft Money™, Quickbooks™, etc. A customer knowledge repository may maintain elements that are useful to identify, authenticate, track and personalize a customer experience when interfacing to the organization via a channel.

For example, the channel specific customer Access ID constructs of the present invention allow a customer to use the customer's social security number or other identifier for web banking and Bank By Phone, and a card number for ATMs. A customer may select among any of the following types of Access IDs for any channel (which may be dependent on channel support), such as Social Security Number (individual); Tax ID Number (business); ATM/debit card number (complete or partial number); bank assigned ID number, personal user ID (i.e., screen name) or others.

In addition, a PIN or password may be used to authenticate the customer to provide secure access. The PIN/password value supported may be chosen by a customer or randomly generated by a system. Customer identification and authentication can be categorized via various methods, such as something a customer knows (e.g., PIN, password, etc.), something a customer possesses that may be physical in nature (e.g., a card, telephone with assigned phone number, etc.); and/or physical characteristics of a customer, which may for instance be biometrics based (e.g., fingerprint, signature, retina scan, etc.). The present invention may be easily extended to support any devised methods of identification and authentication.

A customer knowledge repository of the present invention may retain information pertaining to the selection of a password and may manage the password's use, reset, expiration, encryption, fulfillment, invalid entry attempts, first use control and other operations.

To create a Channel Access entity, a customer may be enrolled for a channel within a customer knowledge repository. Methods of enrollment may include auto-enrollment, self-enrollment, assisted enrollment, and first use enrollment. For example, auto-enrollment may be used for a channel for immediate use by the fact that they have an open, valid relationship with the bank. For example, bank by phone systems may use the auto-enrollment method. Self-enrollment may enable a customer to explicitly indicate that the customer desires to have access through a channel. This method may provide a level of security for the customer if the customer does not want to use a particular channel and fear it may allow others access to their financial information or funds. Self-enrollment may request or require a customer to prove their identity and authenticity. Assisted enrollment may enable a bank's customer service area to open a channel on behalf of the customer. A customer may be identified and authenticated via manual procedures per policy where an online transaction is provided to create a channel entity. For example, Internet banking may use this method, in addition to self-enrollment, when a customer does not have an ATM card or does not feel comfortable entering card number and PIN on the web site during access set-up.

The customer knowledge repository may maintain information pertaining to enrollment, usage (e.g., number of times used, last 5 logons, etc.) and counters used to track the number of times a customer was presented with marketing messages.

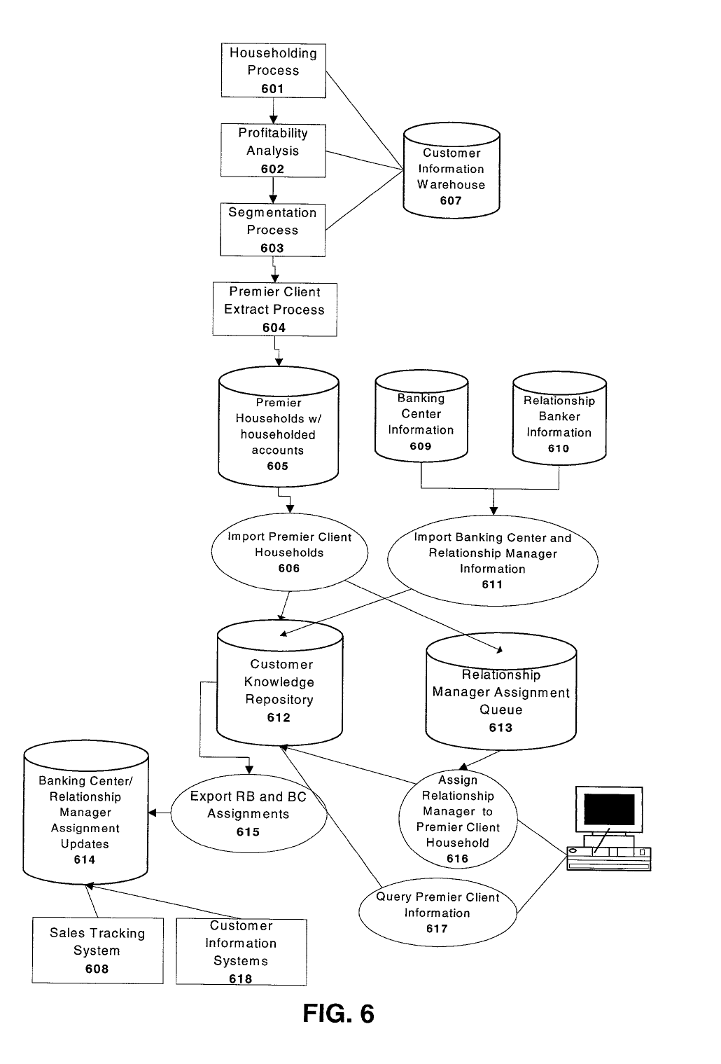

Products owned/held by customers and businesses may be represented as Accounts 305 within the system. For example, account types may include one or more of checking, savings, CDs, IRAs, credit lines, installment loans, mortgages, and credit cards. Accounts may be processed on multiple systems internal and external to an entity (e.g., a bank's time deposit accounting and investment systems). Customers and businesses may have a variety of relationships to one or many accounts. Examples of relationships may include ‘joint primary’, ‘joint secondary’, ‘beneficiary’, ‘signor’, ‘minor’, ‘power of attorney’, and others. A customer knowledge repository of the present invention may receive account numbers, relationships and/or other related information from various customer information systems through its import processes (as illustrated by FIGS. 5 and 6).

A customer knowledge repository of the present invention may maintain a service access 307 profile for each service used by a customer. For example, service types may include basic banking (e.g., account inquiry, account activity review, funds transfer, etc.), bill pay, discount brokerage and other services. Services may be activated for a customer through an enrollment process. To create a profile for a channel, the invention provides methods which may include auto-enrollment, self-enrollment, assisted enrollment and other methods. For example, auto-enrollment may enable a channel to be created for a customer for immediate use when the Customer is initially defined to the Customer Knowledge Repository. Self-enrollment may enable a customer to explicitly request use of the channel. This method provides a level of security and privacy for the customer if they do not wish to use a particular channel or fear that it may allow others to access their information. An example of use of this method is an ATM card sign-up. Assisted Enrollment enables an organization's customer service area to open a channel on behalf of the customer. An organization's system security policy and access tools secure the transactions that enable this method.

The present invention may maintain data pertaining to enrollment of each service. Various factors and restrictions may be specified. For security purposes, services may be restricted from access at a channel level, for example. According to another embodiment, the present invention's business logic may assume that activation of a service is global for all activated channels which support the service. For example, once a customer enrolls for a bill pay service, this enrollment may be applied across all channels that offer bill pay functions. Thus, the present invention provides for consistent treatment and responses to individual customers. As a result, a customer may not be required to proactively effectuate change to all applicable channels (or systems) within a same (similar or related) entity, business etc. The present invention addresses the disadvantages of the current environment where a disparate bill pay (or other) service may be supported for each channel with no information sharing, thereby requiring separate customer enrollment and set up of each channel's system.

According to another embodiment of the present invention, a customer may have one or more group relationships 314 (or associations), such as business relations, family household and/or other affiliations with one or more other individuals or entities. Association data may be tracked and maintained via Customer-to-Household association 315.

For analytical and sales campaign purposes, accounts may be grouped into entities referred to as “households” during the decision support processing cycle. The grouping algorithm may use one or more elements of address, SSN/TIN, and other secondary elements (e.g., phone number, etc.) to perform this function. Households may include units upon which profitability, segmentation, and premier client eligibility may be determined. Each account may be assigned to a single household. Householding may operate on a national grouping of account files and, therefore, cross lines of business, bank IDs, and systems. Customer knowledge repository, with a comprehensive viewing capability, may facilitate household, customer and account views.

In another example, a customer may have financial (and/or other) relationships in multiple households. An example of this scenario may involve an individual who has a primary household and may be contained in a business or relative's household based on account relationships. The ability to view the householded accounts and other relevant data from multiple perspectives may be useful for banking centers, call centers and/or other entities to gain an understanding of elements and data used to determine premier client (or other) status. In addition, a household view may provide another perspective of relationships, not reflected in defined account-to-customer relationships. Households or groups that transition through individual membership re-configurations may be tracked via Household-to-Household Link 316.

Customer contact event 310 may include a call, visit, self-service session or dialogue, or other transaction initiated by or to a customer. A contact may be established between a customer and an entity (e.g., a bank or system) via one or more of the following methods: customer walk-in to banking center; in-bound phone call from customer to call center; out-bound phone call from call center to customer; in-bound e-mail from customer to customer service; out-bound e-mail from call center to customer service; customer session via interactive Voice Response (VRU); customer session via bank's web site (e.g., account transactions, bill pay, etc.); customer session via ATM; customer session via Point of Sale (POS); customer session via Quicken, Microsoft Money, or Quickbooks (e.g., account transactions, e-mail, and bill pay, etc.); customer transaction via banking center teller; in-bound postal mail or expressed correspondence from customer; out-bound postal mail, expressed correspondence, and sales campaign offer to customer; direct sales via sales force (e.g., Relationship Manager) and other forms of contact. Event details 311 may include various specifics of the customer contact event.

Types of events may include one or more of service request; complaint; comment; survey; request for information (e.g., product rates, terms, locations, etc.); promotion or solicitation of a product or service; product or service application; account-based transaction executed by customer or on behalf of customer by bank personnel and others. An example of an event may be a service request to change the addresses for all of the customer's accounts. Any of the event types may occur via any channel.

Multiple contact events may be related to one another via a Contact Case 309. Contact Case 309 may link together events that are involved in the same (similar or related) event. For example, an initial call, a follow-up call, and a visit to a banking center pertaining to the occurrence of a single problem may be considered part of the same case. An event workflow item link 312 may relate to an action to be taken on a single account or an entry to a back-end workflow system. In the example of an address change request, several accounts may be maintained to satisfy this request. Each would have an event workflow item link since each workflow task involves a separate action on a unique record.

Through the course of a customer's lifetime, financial goals and needs may vary. Individual or business financial needs 316 may be the result of long or short term plans or required on an emergency basis. An example of these types of needs include upcoming college expenses, plans to purchase a new home, and an expansion of business. Knowledge pertaining to a customer's needs may be obtained via surveys, face-to-face interaction, phone conversations, an interactive session on a self-service channel or through other information gathering methods. Regardless of the method used to obtain knowledge about the need, the present invention provides a repository where information may reside in a common, openly accessible repository that enables easy and quick access to the information by areas (e.g., systems, departments, etc.) of an entity (e.g., a bank) or other factors or queries.

The customer specific needs that are collected may be input into a marketing analytical process to determine if a current product satisfies a customer need, or possibly, a new product should be developed based on a large population of an unsatisfied need. According to another embodiment of the present invention, customer defined “intelligent agents” may perform event driven searches and responses. An example may involve a customer requesting contact when interest rates reach a specified percentage, or an account balance reaches a specified dollar amount goal, or customer account is within a specified timeframe before maturity. Other triggers may also be identified. In addition, other data, such as communication preferences 313, may be maintained by the customer knowledge repository.

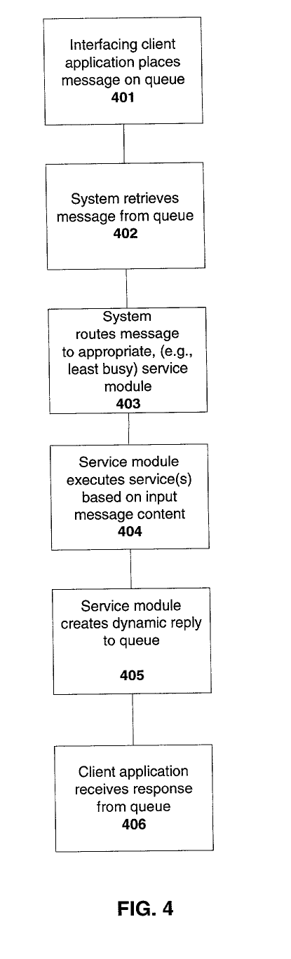

FIG. 4 is a flowchart illustrating communication using a consistent application programming interface, according to an embodiment of the present invention. For example, transaction and delivery systems may use the application programming interface to locate a customer, receive a profile, receive and update customer relationships, access, and preferences. At step 401, an interfacing client application may place one or more request messages on a common queue provided or defined by the present invention. At step 402, the system of the present invention may then retrieve the one or more messages from the queue. A message queue may be a destination to which messages may be sent. Messages may accumulate on queues until the messages are retrieved by programs that service those queues. Programs may access queues through external services of a queue manager. For example, a store-and-forward protocol may be implemented to ensure proper delivery of messages between (or among) applications. Queuing may include a mechanism by which messages may be held until an application is ready to process them. There may be no or minimal physical connections between applications that communicate using message queues. For example, queuing may enable communication between programs (which may run in different environments) without having to write the communication code. Also, the queuing feature may enable selection of the order in which a program processes messages. Balance of loads on a system may also be achieved by arranging for more than one program to service a queue when the number of messages exceeds a predetermined threshold. Queuing may also provide an increase in the availability of applications by arranging for an alternative system to service the queues if the primary system is unavailable. Other variations and services may be implemented.

A dynamic routing process within the invention may determine which one of its multiple functional processes is appropriate to handle the request message based on current message volume and the requested function. The invention, at any point in time, has several functional processes executing in multiple computer processors or regions. At step 403, the system may dispatch the request message to an appropriate (e.g., the least busy) service module. At step 404, the service module may execute the requested service based on the input elements of the message. Prior to placing a request message on the invention's queue, each client application may create an application specific dynamic reply-to-queue to which the present invention may place the response message, at step 405. The client application may then retrieve a corresponding response from the queue, at step 406.

FIG. 5 is an example of a logic flow for importing customer information and relationships into a customer knowledge repository, according to an embodiment of the present invention. In particular, a method for creating customers and Authorized Agents on the customer knowledge repository from a system that contains a customer definition is presented. At step 501, a System of Record (SOR) may be identified to contain a data store of customer that may be recognized in the customer knowledge repository. The SOR creates a feeder file in the standard format defined by the invention, at step 502. As each customer is added to the customer knowledge repository, a unique identification number may be assigned, at 503. This number makes the customer's repository record key unique globally across the entire repository customer base independent of the record key known in the SOR. This method allows for any customer SOR source to be imported into the repository. If the customer is a business entity rather than an individual, a “business template” customer entry is created within the repository containing the business' profile, at step 504. Then as each individual within the business with access rights to an account is identified, an Authorized Agent entry may be tied to the business template entry. If the customer is identified as a non-business individual consumer then a single Authorized Agent entry may be created, at step 505. This method maintains a consistent approach which allows a common architecture to be used for consumers and businesses. Each account definition may be extracted from the SOR customer and accounting systems and related to the appropriate customers, at step 506. Account Access profiles may be created using the prescribed policies of the organization as defined within predefined matrices to set access defaults for transaction and channel access entitlements. External systems that contain service definitions (e.g., bill payment system) may also be imported into the customer knowledge repository using a created message standard, at step 507. Auto-enrolled Channel and Service entities may be created at step 508. Relationship links, such as account-to-customer, service-to-account, and channel-to-account, may be created at step 509. According to an embodiment of the present invention, the method of FIG. 5 allows a batch or online, real-time feed using a common and standard message format and shared system logic.

FIG. 6 illustrates an example of a logic flow for importing and exporting relationship scoring, householding, and Relationship Manager assignment information to and from a customer knowledge repository, according to an embodiment of the present invention. A customer knowledge repository of the present invention may be used in various applications. For example, a customer knowledge repository may be used by a premier client project system for managing banking center and relationship banker assignments, determining customers with households (or other defined grouping), and distributing premier client (or other status) information to bankers and delivery channels. Other applications may be implemented.

Establishments, such as banks, may identify premier households and set an indicator within a customer record of the primary accountholder. Customers of a premier status may be entitled to various benefits and advantages. For example, premier customers (i.e., clients) may be offered special servicing, a priority problem resolution, fee refund requests, and expedited provisional credit for deposits and loans. Oftentimes, premier client (or other status) determination may cross banks, systems, applications and/or entities. Other customer status indicators may be identified by an entity.

Within the banking application, deposit and loan accounts may be combined across multiple lines of business and grouped within an association (e.g., household) using a prescribed algorithm, as illustrated by householding process 601. The householding algorithm groups accounts may be based upon name and/or other demographic information. Once grouped accordingly (e.g., householded), the households' profitability, segment and other metrics may be calculated, at profitability analysis 602. For example, from within a “relationship” segment, a specified top percentage may be deemed to be “Premier Client” households. In addition, a household may be assigned to a banking center (or other appropriate entity) or otherwise segmented, at segmentation process 603. A repository of customer information may be retrieved into analytical processes from Customer Information Warehouse 607. Other sources of customer data may be accessed as well.

A Banking Center Manager (BCM) may be responsible for managing various aspects of an assigned location. An Assistant Banking Center Manager (ABCM) may work with the BCM to handle management responsibilities and accountabilities. Relationship Banker (RB) may have the role of servicing customers by managing an assigned portfolio of customers (e.g., premier clients and other clients). The RB may have the responsibility of maintaining, retaining, and growing an assigned customer base. Banking Center Manager (BCM) may be responsible for assigning premier customer (or other identified) households to Relationship Bankers within a banking center or other location. Information pertaining to banking centers and relationship management staff structure may be maintained in the customer knowledge repository, as illustrated by Banking Center Information 609 and Relationship Banker Information 610.

When a premier client is identified, the client may be directed to an assigned relationship banker for servicing, at 616. Further, a RB may be proactive and actively monitor and market the assigned premier client base. Therefore, a system of the present invention may provide a mechanism for identifying a customer as premier at the point of contact and facilitating the ability to mine and monitor a customer's financial situation and other information, through queries at 617. In another example, a relationship banker may be responsible for customers within assigned households.

In addition, individuals within the household, not households themselves, may also perform transactions and make contact with bankers. Therefore, all customers who are accountholders with any relationship to the accounts within the household should be recognized as “Premier Clients” as well. Premier client or other status data may be extracted at 604. Premier households with householded accounts and other data may be stored at 605. Other levels (and/or status indicators) of Premier (e.g., silver, gold, platinum) may be implemented. During an import of households or other grouping, as shown by 606, every account within a household may be used by the present invention to determine each and every individual related to the accounts. The household-to-account and household-to-customer relationship links may be created by the present invention. Relationship manager assignments may be stored in queue 613 for subsequent assignments.

The present invention may provide a relationship banker with the ability to substantiate the “Premier” status of a customer. Traditionally, this ability has been an issue with analytical marketing systems available. For example, substantiation of a status may include the ability to view householded accounts and the elements which went into the Premier Client determination (e.g., 3 month average balance, total loan amount, the existence of securities in the household portfolio, etc.).

In another example, a customer may have relationships to accounts, which may be grouped within multiple households. In addition, a customer may have individual and business relationships with an entity (e.g., a bank). In this example, a customer may want to have all of the customer's relationships considered to achieve a premier (or other) status. In addition to views at a household level, the present invention provides household (e.g., group) views at the customer and account levels satisfying the requirements set forth in the previous examples.

Banking center, relationship banker and other information may be imported into the customer knowledge repository 612, as illustrated by 611. For example, a relationship banker may be assigned to a premier client household, as illustrated by 616.

As illustrated by 615, relationship banker and banking center assignments may be exported to an identified destination, such as database 614 for banking center and relationship banker updates and other operations. This step enables the return of relationship banker and modified banking center assignments to sales tracking systems 608 and customer information systems 618.

FIG. 7 is an example of a data model of a customer knowledge repository, according to an embodiment of the present invention. Each box represents an entity within the data model which may include a set of relational database tables associated with a customer knowledge repository. Other entities beyond those depicted here may exist to define administrative tables containing codes and set-up defaults. In particular, the data model of the present invention provides for the separation of customer 710 and Authorized Agent 720 profile to facilitate business relationships. Customer Information System Link 712 facilitates linkages between multiple back-end customer information system sources and a single customer definition. Name Index 714 facilitates a global search by name function across some or all of the enterprises customer systems.

Account Access 734 may be created for each account related to every individual Authorized Agent 720. This provides for a personalized and customized view defined by the customer. As with the use of a global customer id, each account may also be given a unique identifier thereby separating an accounting system of record keys from the repository. This method of the present invention facilitates account conversions. For example, when an account number changes in the system of record, an attribute may be updated within the repository but no primary key may be impacted. Account Access 734 profile may contain one or more of account identity (e.g., bank number, product type, account number, etc.), sub-type (e.g., sub-product), transaction level access permissions, channel level access restrictions, personalized nickname for account, short reference code for account, indicators (e.g., directs the interfacing channel to automatically trigger a balance inquiry on the account without requiring a customer specified inquiry transaction) and other information. For example, the described capabilities allow a customer to specify which accounts the customer wants to be presented at a specific channel and a nickname that they would like to use for the account. Through the use of a nickname and a global account identifier, the actual account number may not have to be transmitted over the Internet. Another feature of the present invention may include an Auto-Play Indicator that allows a customer to specify the accounts that the customer would like to hear related information from, such as account balances, automatically upon successful log-on, for example. Other triggering events may be defined. As the interfacing channel receives the profile, account balance inquiries for each of the specified accounts may be triggered. As a result, this feature of the present invention saves the customer time in entry and reduces an entity's “1-800” phone expense by shortening the call time.

Service Access 730 and Channel Access 732 may be related to each Authorized Agent 720 and relate services and delivery channels respectively. Unique methods supported by the Channel Access 732 entity include Auto-Play at the channel level (in addition to the account level as previously described) and Message Play. Message Play supports the display or playing (with Interactive Voice Response) of marketing messages up to a predetermined number of times. For example, as each log-on request from an interfacing channel is successfully processed and customer log-on is achieved, the counter may be incremented and the message number to play/display may be returned in the customer profile message sent upon successful log-on. As a new marketing message is defined and placed in the Channel Access of the repository, the message play counter may be reset to zero.

Contact history may be maintained in the customer knowledge repository within a predetermined number (e.g., four) of data entities. The architecture of the present invention may be designed and constructed to handle multiple types of contact events including one or more of service requests, comments, complaints, solicitations, courtesy calls, surveys and others. The customer knowledge repository may be designed to frame contact events with a Contact Case to provide a mechanism to link contacts together. This capability allows a sequence of contacts (e.g., calls, walk-ins, email, mail, etc.) related to the same (similar or related) problem or event to be “framed” together in a relationship. Contact Event 738 may define attributes about each event that occurs. Information pertaining to the origin, type, status, due date and/or other factors may be captured within the repository. Unique IDs may be defined for the case (i.e., event frame) and the event, at 736. Specific details about the event may be maintained in a separate entity, as illustrated by Event Detail 740. Event Detail 740 may occur multiple times for a single event depending on the number of elements and size of data that may need to be stored. Event data received in XML or any other format (as defined by the format type in the message) may be parsed and retained in a storage-efficient internal structure. The method of the present invention saves storage space that is traditionally a problem with the verbose nature of XML. Further, the structure and nesting characteristics of XML may be maintained and preserved. The creation of a common markup vocabulary for contact events may serve to avoid problems with the recognition and collision of a multitude of data. To achieve the requirement for a common vocabulary, the structure, syntax, and semantics may be enforced within a contact domain. Through a common vocabulary, data components may be translated into internal business objects for use within the entire enterprise rather than just the interface application that originated the message. The present invention may implement a common vocabulary for contact management and other areas, according to an embodiment of the present invention.

Another entity in a contact history group of entities may include Event Workflow Item 742. Many enterprises have workflow systems to manage problem tracking and resolution. Event Workflow Item 742 provides a link to an event in a repository to a workflow system by maintaining the workflow system ID and keys. Therefore, a delivery channel system may obtain a perspective of contacts with the customer complete with a set of links to the back-end workflow systems that allow the delivery channel system the means to drill down directly to an appropriate work-flow system record.

Communication Preferences 722 provides a repository area for customer contact information including fax number, email address, related phone numbers, a customer's preferred and non-preferred (“opt out”) method to communicate with the enterprise, a customer's preferred day(s) of the week and times for contact and other preference data. Household 724 and Household-to-Household Link 726 provides a mechanism for grouping customers and provides various grouped views. Household 724 may store household level information including status, address, banking center and relationship banker assignments, premier client elements and/or other data. Household-to-Household Link 726 allows for a household (or other defined unit/grouping) to relate to another household (or other defined unit/grouping). Link actions may be available for merges, splits, hierarchical and other relationships. For example, a marriage between two customers may represent a merged household. A divorce may represent a split household. A large business with multiple districts, regions, and a home office represent an example of a hierarchical relationship. Financial Need/Event 728 may provide information related to specific needs and other events that may impact a customer's financial status.

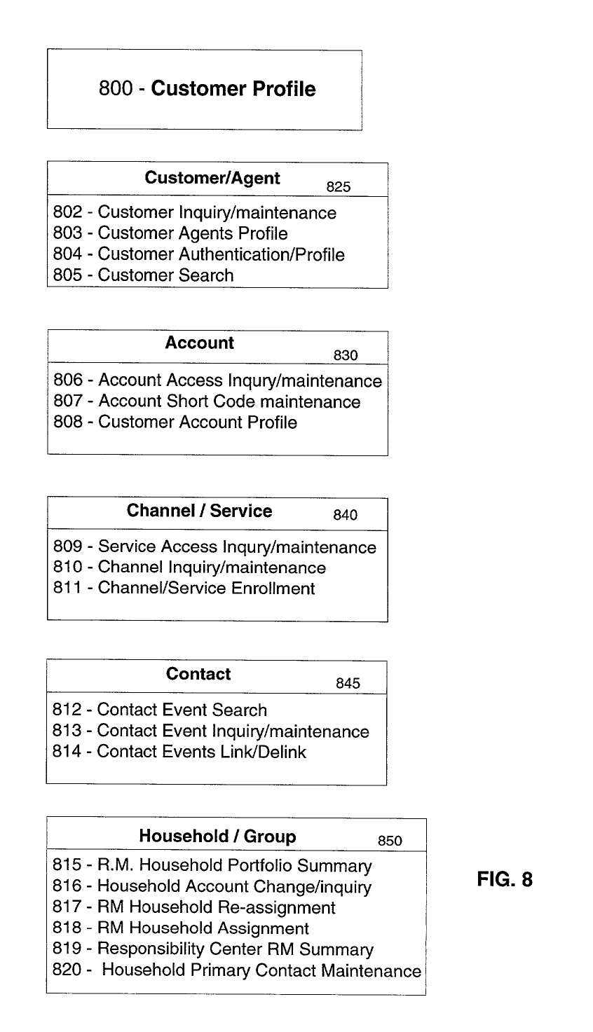

FIG. 8 is an illustration of a set of functions that interact on a Customer Knowledge Repository to provide an interfacing system, according to an embodiment of the present invention. For example, various standard functions may be applied to profile functions of the present invention. A set of message formats and elements may be defined to invoke functions that may act upon a Customer Knowledge Repository. Each message received from a client interface system may be independent of other messages. To facilitate a multiple message interaction, information may be returned within each response message that may be used to create the next request and emulate a conversational mode dialog between a client delivery system application and the present invention. Therefore, the architecture of the present invention may separate the ‘presentation layer’ or user interface (e.g., Internet, audio, “dumb” terminal, ATM, etc.) from the Customer Knowledge Repository and related functions.

Customer Profile 800 provides an overall view of a customer with links to other customer systems of record, activated channels, related accounts, events (e.g., total and open status, etc.), authorized agents and others. This profile may provide a client delivery channel system with the basis for other profiles to follow. Other customer specific functions 825 may provide detailed information for retrieval and update. Functions may include Customer Inquiry/Maintenance 802, Customer Agents Profile 803, Customer Authentication/Profile 804, and Customer Search 805.

Another set of functions may be available for account related queries and maintenance, as illustrated by 830. Functions may include Account Access Inquiry/Maintenance 806, Account Short Code Maintenance 807, and Customer Account Profile 808. Other functions may be available for channel and service profiling 840. This set of functions may include Service Inquiry/Maintenance 809, Channel Inquiry/Maintenance 810, and Channel/Service Enrollment 811.

Contact 845 related functions may allow for searching and maintaining the customer knowledge repository. Contact functions may include Contact Event Search 812, Contact Event Inquiry/Maintenance 813, and Contact Event Link/Delink 814.

Another set of functions may relate to inquiring upon and maintaining households or other groupings, as illustrated by 850. In addition, this function set may include the capabilities to assign responsibility and view accountability of relationship managers. This set may include Relationship Manager's Household Portfolio Summary 815, Household Account Inquiry/Maintenance 816, Relationship Manager's Household Reassignment 817, Relationship Manager's Household Assignment 818, Responsibility Center's Relationship Manager Premier Client Summary 819, and Household Primary Contact Maintenance 820. These functions provide an array of customer management capabilities for banks and other types of enterprises in a single system architecture and platform. In accordance with the present invention, other functions may be implemented as well.

The foregoing description of the system and method for customer knowledge repository is illustrative, and variations in configuration and implementation will occur to persons skilled in the art. Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for linking multiple customer information systems, comprising the steps of:
identifying at least one customer by a global identifier across multiple customer information systems;
applying a relationship algorithm to relationship data to associate the customer with one or more other entities across the multiple customer information systems for association in a group relationship;
storing customer profile data and relationship data in a centralized database according to the global identifier;
tracking one or more contacts associated with the customer; and
accessing relationship data and customer profile data in a consolidated profile view.

2. The method of claim 1 wherein the group relationship is determined by demographic information, which comprises one or more of common address data and common telephone data.

3. The method of claim 1 wherein the group relationship comprises one or more of business, personal household, and community of interest organizational structures.

4. The method of claim 1 wherein the customer is associated with multiple group relationships.

5. The method of claim 1 comprising a step of applying status data to the group relationship wherein status data is determined as a predetermined top percentage of customers based on profitability.

6. The method of claim 1 wherein the consolidated profile view displays one or more factors used in determining customer profitability status.

7. The method of claim 1 further comprising a step of exchanging information with at least one channel delivery system wherein the information is linked to at least one back-end system.

8. The method of claim 1 wherein customer profile data comprises one or more of transaction history, profitability analysis data, customer contact data, preference data, privacy data, demographic data, psychographic profile data, relationships to other customers or organizations, channel usage data, methods of identification and authentication used to recognize the customer at a point of contact.

9. The method of claim 1 wherein contact comprises one or more of self-service customer transactions, full-service transactions, inbound and outbound calls, marketing campaigns, email, and back-office operational contact with the customer.

10. The method of claim 7 wherein the back-end system comprises one or more of customer system, account system, workflow system and analytical system.

11. The method of claim 7 wherein the delivery channel system comprises one or more of Automated Teller Machines (ATMs), Interactive Voice Response (IVR), Point of Sale (POS), Personal Financial Management (PFM), call center, banking center, Sales Force Automation (SFA), and Internet.

12. The method of claim 7 further comprising a step of implementing a standardized client interface wherein the standardized client interface is accessed by each channel delivery system.

13. The method of claim 1 wherein customer profile data comprises association data which comprises one or more of account-to-customer, service-to-account and channel-to-account associations.

14. The method of claim 1 further comprising a step of querying the centralized database to identify a customer having a predetermined status at a point of contact and to facilitate the ability to monitor the customer's financial situation.

15. A system for linking multiple customer information systems, comprising:
identification means for identifying at least one customer by a global identifier across multiple customer information systems;
application means for applying a relationship algorithm to relationship data to associate the customer with one or more other entities across the multiple customer information systems for association in a group relationship;
storing means for storing customer profile data and relationship data in a centralized database according to the global identifier;
tracking means for tracking one or more contacts associated with the customer; and
access means for accessing relationship data and customer profile data in a consolidated profile view.

16. The system of claim 15 wherein the group relationship is determined by demographic information, which comprises one or more of common address data and common telephone data.

17. The system of claim 15 wherein the group relationship comprises one or more of business, personal household, and community of interest organizational structures.

18. The system of claim 15 wherein the customer is associated with multiple group relationships.

19. The system of claim 15 comprising status means for applying status data to the group relationship wherein status data is determined as a predetermined top percentage of customers based on profitability.

20. The system of claim 15 wherein the consolidated profile view displays one or more factors used in determining customer profitability status.

21. The system of claim 15 further comprising an exchange means for exchanging information with at least one channel delivery system wherein the information is linked to at least one back-end system.

22. The system of claim 15 wherein customer profile data comprises one or more of transaction history, profitability analysis data, customer contact data, preference data, privacy data, demographic data, psychographic profile data, relationships to other customers or organizations, channel usage data, methods of identification and authentication used to recognize the customer at a point of contact.

23. The system of claim 15 wherein contact comprises one or more of self-service customer transactions, full-service transactions, inbound and outbound calls, marketing campaigns, email, and back-office operational contact with the customer.

24. The system of claim 21 wherein the back-end system comprises one or more of customer system, account system, workflow system and analytical system.

25. The system of claim 21 wherein the delivery channel system comprises one or more of Automated Teller Machines (ATMs), Interactive Voice Response (IVR), Point of Sale (POS), Personal Financial Management (PFM), call center, banking center, Sales Force Automation (SFA), and Internet.

26. The system of claim 21 further comprising implementation means for implementing a standardized client interface wherein the standardized client interface is accessed by each channel delivery system.

27. The system of claim 1 wherein customer profile data comprises association data which comprises one or more of account-to-customer, service-to-account and channel-to-account associations.

28. The system of claim 1 further comprising query means for querying the centralized database to identify a customer having a predetermined status at a point of contact and to facilitate the ability to monitor the customer's financial situation.
